(19) United States
(12) Patent Application Publication
(10) Pub. No.: US 2022/0300965 A1
(43) Pub. Date: Sep. 22, 2022

(54) SMART TRANSACTION DEVICE WITH MULTIPLE FINGERPRINT RECOGNITION

(71) Applicant: Decentralized Biotechnology Intelligence Co., Ltd., Taipei City (TW)

(72) Inventors: Yen-Han Chou, Taipei City (TW); Yao-Sheng Chou, Taipei City (TW)

(21) Appl. No.: 17/516,628

(22) Filed: Nov. 1, 2021

(30) Foreign Application Priority Data
Mar. 22, 2021 (TW) 110110241

(51) Int. Cl. G06Q 20/40; G06K 9/00; G06F 21/32; G06Q 20/38

(52) U.S. Cl. CPC G06Q 20/401; G06K 9/0002; G06F 21/32; G06Q 20/3821

(57) ABSTRACT

A smart transaction device with multiple fingerprint recognition includes a device body having a first surface and a second surface on the opposite side, a plurality of fingerprint sensing devices being respectively arranged on the first surface and the second surface to individually sense the fingerprints of different fingers of a user and store them in the memory as comparison data.

### CROSS-REFERENCE TO RELATED APPLICATIONS

This patent application is based on, and claim priority from TAIWAN patent application serial number 110110241, filed on Mar. 22, 2021, the disclosure of which is hereby incorporated by reference herein in its' entirety.

### TECHNICAL FIELD

The present invention relates to a smart transaction device, and more particularly, relates to a smart transaction device with multiple fingerprint recognition.

### BACKGROUND OF RELATED ARTS

Recently, payment technologies that do not involve currency or material money have been developed, various simpler means for performing payment services are proposed, for example, utilizing smart transaction devices with IC chips to proceed transactions or payments. In addition to non-cash transactions commonly used by consumers such as credit cards and debit cards, various kinds of payment/transaction devices have been commercialized due to the rise of e-commerce and remote payment, such as smartcard that combines electronic tickets (stored-value cards, all-in-one cards . . . etc.) or various credit/debit cards have been widely used. Payment convenience of these cards and their high degree of security during the payment process are very important, these aspects should be seriously considered while proposing a novel payment method.

Utilizing smart transaction devices, including but not limited to, for example, various kinds of debit card, credit card, and electronic ticket to make payments in transactions are the traditional payment methods. In recent years, consumers are used to utilize the aforementioned smart transaction devices in financial transactions, such as purchasing goods (products) and/or services from stores, due to the rise of e-commerce and the rapid development of remote payment. Payment cards (such as ATM cards, etc.), having same or different account, can also be used to withdraw funds and/or transfer funds from the payment account associated with that card. In these financial transactions, various verification methods for these cards are usually used to ensure that owners of payment cards are actually authorized to use them. Known verification methods for these cards include user's signatures and personal identification codes.

In spite of attached security devices of these cards (smart transaction deice) are used by the consumer during transactions, however, in some cases it is still allowed to use smart transaction devices (for example, smart financial cards) during payment process and bypassing the attached security devices without applying any separate security devices. Therefore, it cannot prevent illegal use of these smart transaction devices (for example, smart financial cards) and theses devices are easy to be lost or stolen.

In response to the above-mentioned security concerns, the commercial demand for biometrics applications on these devices has rapidly increased. For security considerations of the smart transaction devices (for example, verification of smart financial cards), considering their efficiency, security, and non-intrusive requirements, applying fingerprint recognition technology to smart transaction devices has become a convenient and safe choice.

However, currently issued smart transaction devices with fingerprint recognition function, such as smart financial cards, they are usually provided a single fingerprint recognition device only, such as thumb fingerprint reading device. Although the user's biometric features are added in the smart financial card, it can still be fraudulently used by unauthorized people.

### SUMMARY

In order to solve the above drawbacks, the present invention proposes a smart transaction device with multiple fingerprint recognition, which includes a device body having a first surface and a second surface on the opposite side, a plurality of fingerprint sensing devices being respectively arranged on the first surface and the second surface to individually sense the fingerprints of different fingers of a user and store them in the memory as comparison data.

In one preferred embodiment, the plurality of fingerprint sensing devices include full fingerprint recognition, and the plurality of fingerprint sensing devices are arranged on the first surface and the second surface.

In one preferred embodiment, the device body further includes a microcontroller and a memory, the microcontroller is electrically connected to the plurality of fingerprint sensing devices to receive a plurality of fingerprint data of the user, and performs fingerprint registration or fingerprint comparison based on the plurality of fingerprint data.

In one preferred embodiment, the plurality of fingerprint sensing devices are capacitive fingerprint recognition sensors.

In one preferred embodiment, the plurality of fingerprint sensing devices are fingerprint recognition sensors manufactured by printing, photolithography and etching, laser transfer, fine metal mask sputtering or slit coating process.

In one preferred embodiment, the smart transaction device includes all kinds of financial cards, credit cards, electronic tickets, smart ID cards, access cards, fingerprint cards (keys) of laptops or similar electronic devices, remote controls, mobile phones, or USB containing confidential information Flash drive.

In one preferred embodiment, materials of the smart transaction device includes plastic, glass, flexible film, or metal.

In one preferred embodiment, the smart transaction device with multiple fingerprint recognition further includes a status display device controlled by a microcontroller to generate visual verification status prompts of the smart transaction device.

In one preferred embodiment, the plurality of fingerprint sensing devices are arranged on the first surface of the device body and the second surface on the opposite side, their configurations are based on user's way of holding the smart transaction device.

A method of operating a smart transaction device with multiple fingerprint sensing devices, the smart transaction device having a plurality of fingerprint sensing devices been configured at least on one of a first surface of the smart transaction device and a second surface on the opposite side thereof, and been configured in accordance with user's way of holding the smart transaction device, the method includes activating fingerprint sensing system of the smart transaction device, verifying whether input multiple fingerprint information through the plurality of fingerprint sensing devices is the user's preset fingerprint configuration information, if verification is failed, the smart transaction device requests a re-identification process, and proceeding with transaction after completing verification of the input multiple fingerprint information.

In one preferred embodiment, the method of activating fingerprint sensing system is to use the user's thumb to press the fingerprint sensing device on the first surface of the smart transaction device for more than a predetermined period of time.

In one preferred embodiment, the method of verifying whether the input fingerprint information is the fingerprint configuration information preset by the user is to transmit the user's real time fingerprint combinations to a microprocessor and compare them with the user's preset and stored fingerprint combinations, and then check if they are matched by the microcontroller.

In one preferred embodiment, the microcontroller is embedded inside the smart transaction device.

In one preferred embodiment, the user's fingerprint combination is determined by different combinations of the user's ways of holding the smart transaction device.

In one preferred embodiment, the user's fingerprint combination is determined by different combinations of the user's ways of holding the smart transaction device.

In one preferred embodiment, the method of operating a smart transaction device with multiple fingerprint sensing devices further includes detecting the posture or manner of the user's fingers holding the smart transaction device to detect whether the user is in the default emergency situation.

### BRIEF DESCRIPTION OF THE DRAWINGS

The components, characteristics and advantages of the present invention may be understood by the detailed descriptions of the preferred embodiments outlined in the specification and the drawings attached:

FIGS. 1(A)-1(D) illustrate the appearance configuration diagram of the smart transaction device with fingerprint sensing device according to a preferred embodiment of the present invention.

FIG. 2 illustrates the system architecture of the smart transaction device with fingerprint sensing device according to a preferred embodiment of the invention.

FIG. 3 illustrates the data flow between the multiple sensing devices and both the microprocessor and memory located inside the fingerprint sensing system according to a preferred embodiment of the present invention.

FIG. 4 illustrates a cross-sectional view of the smart transaction device with fingerprint sensing device according to a preferred embodiment of the present invention.

FIG. 5 illustrates a flow chart for operating the smart transaction device according to an embodiment of the present invention.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

Regarding the “connected” or “electrical coupled” used in this specification, it can mean that two or more components are directly physically connected or electrically contacted with each other, or indirectly physically connected or electrically contacted with each other, and ““connected” or “electrically coupled” can also refer to two or more components interoperating or acting.

To solve the issue that the smart transaction card will still be fraudulently used by unauthorized persons, even the user's biometric function is added to the smart transaction device. The present invention proposes a smart transaction device with multiple fingerprint recognition. Multiple fingerprint sensing areas are set on the top and bottom surfaces of the smart transaction device and make their pattern configuration matching user's hand-held way of holding device. The smart transaction device here is referred to, but is not limited to, for example, various financial cards, credit cards, and electronic tickets, which can also include such as smart ID cards, additional fingerprint keys (cards) of laptops or similar electronic devices, access control cards, remote controller, mobile phone, or USB flash drive containing confidential information, etc.

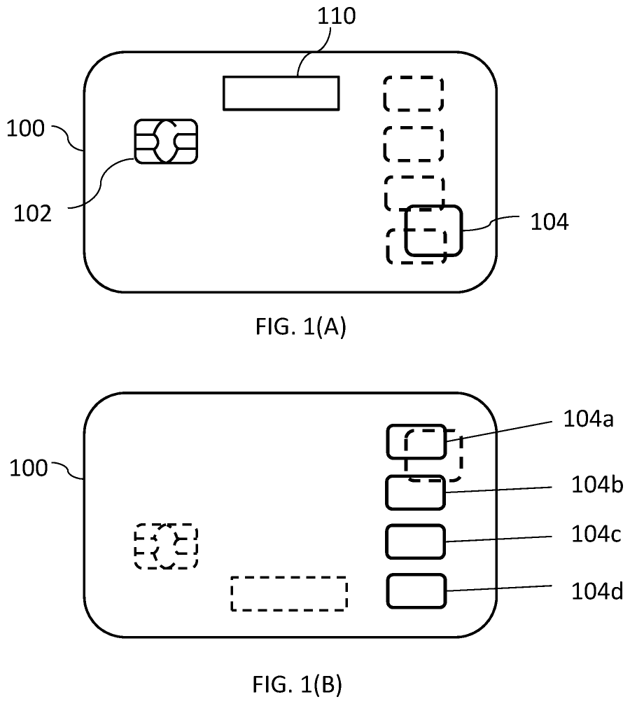

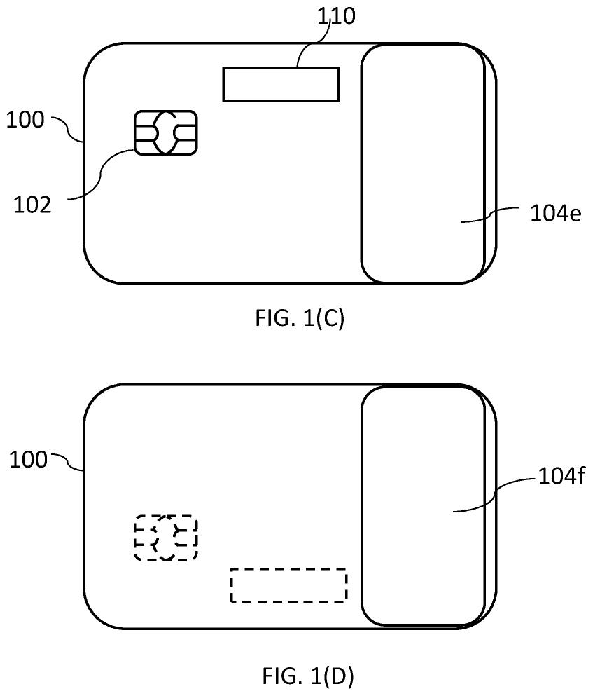

FIG. 1(A)-1(B) shows an embodiment of the external configuration diagram of the smart transaction device with fingerprint sensing devices according to the present invention, FIG. 1(A) and FIG. 1(B) show the front side and back side of the smart transaction device, respectively. The smart transaction device 100 includes an IC chip 102, a status display device 110, and a plurality of fingerprint sensing devices 104, 104a, 104b, 104c, and 104d. According to one embodiment of the present invention, among the plurality of fingerprint sensing devices, the fingerprint sensing device 104 is disposed on the front side of the smart transaction device 100, and the remaining plurality of fingerprint sensing devices 104a, 104b, 104c, and 104d are disposed on the back side of the smart transaction device 100. An alternative configuration of the above embodiment, i.e. swapping the configuration of the fingerprint sensing device between the front side and back side, still belongs to one aspect of the present invention. The smart transaction device 100 provides settlement information or user identification information stored in the IC chip 102 in the case of a legitimate user's fingerprint been identified, and performs actions such as card settlement or user identification. In one preferred embodiment of the present invention, the above-mentioned plurality of fingerprint sensing devices 104, 104a, 104b, 104c, and 104d are capacitive fingerprint recognition sensors. In order to improve the fragility and excessive thickness of traditional chip-type (hard-type) fingerprint sensing devices, the present invention proposes a flexible fingerprint recognition sensor manufactured by a printing process. Comparing with the traditional technology, which does not have the multiple fingerprint verification method, the technical features of the present invention involving multiple fingerprint verification approach can strengthen the security control. The fingerprint recognition sensor mentioned above can be manufactured not only by printing process, but also a variety of patterning processes such as photolithography and etching, laser transfer, fine metal mask (FMM) sputtering or slit coating.

FIG. 1(C)-1(D) shows another embodiment of the external configuration diagram of the smart transaction device with fingerprint sensing devices according to the present invention, FIG. 1(C) and FIG. 1(D) show the front side and back side of the smart transaction device, respectively. The smart transaction device 100 includes an IC chip 102, a status display device 110, single-sided full fingerprint sensors 104e and 104f which are respectively disposed on the front side and back side of the smart transaction device 100. An alternative configuration of the above embodiment, i.e. swapping the configuration of the fingerprint sensing device between the front side and back side, still belongs to one aspect of the present invention. The smart transaction device 100 provides settlement information or user identification information stored in the IC chip 102 in the case of a legitimate user's fingerprint been identified, and performs actions such as card settlement or user identification. In one preferred embodiment of the present invention, the above-mentioned single-sided full fingerprint sensing devices 104e and 104f are capacitive fingerprint recognition sensors. The single-sided full fingerprint sensing devices 104e and 104f mentioned above can be manufactured not only by printing process, but also a variety of patterning processes such as photolithography and etching, laser transfer, fine metal mask (FMM) sputtering or slit coating.

According to a preferred embodiment of the present invention, the material of the above-mentioned smart transaction device includes plastic, glass, flexible film, or metal.

The above descriptions provide examples of related configurations for a plurality of fingerprint sensing devices in a smart transaction device, various combinations of fingerprint sensing devices in the smart transaction device still belong to one aspect of the embodiments of the present invention. For example, a fingerprint sensor 104 is configured to be on the front side of the smart transaction device as shown in FIG. 1(A), and a single-sided full fingerprint sensor 104f is configured to be on the back side of the smart transaction device as shown in FIG. 1(D); or, for example, a single-sided full fingerprint sensing device 104e is configured to be on the front side of the smart transaction device as shown in FIG. 1(A), and a plurality of fingerprint sensing devices 104a, 104b, 104c, and 104d are configured to be on the back side of the smart transaction device as shown in FIG. 1(B).

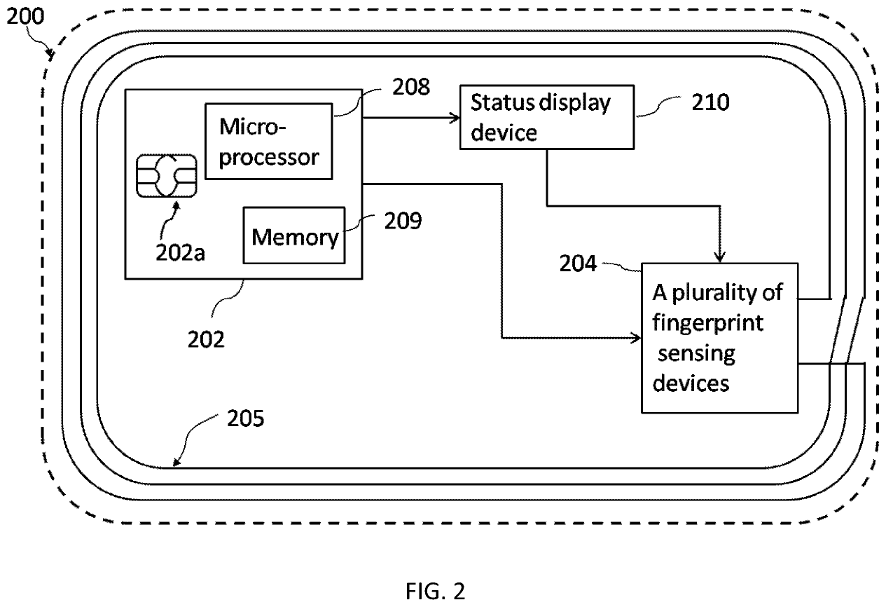

FIG. 2 shows the system architecture of the smart transaction device 200 with fingerprint sensing devices proposed by the present invention. The smart transaction device 200 can obtain electric power from another electronic device, such as a card reader, ATM, etc., and supply the electric power to a plurality of fingerprint sensor devices 204 through the chip 202, and the smart transaction device 200 can also get electric power from a near field communication (NFC) antenna 205 through its coil to sense a card reader or similar electronic device and supply the electric power to a plurality of fingerprint sensing devices 204 as shown in FIG. 1(A)-1(B) (or the single-sided full-fingerprint sensing devices 104e, 104f configured to be on the front and back sides of the smart transaction device as shown in FIGS. 1(C)-1(D)).

A user utilizes the smart transaction device 200 to conduct a transaction, the user can choose non-contact sensing approach or can directly contact the chip 202 to obtain electric power. When the user conducts a transaction with non-contact sensing approach, the smart transaction device 200 is nearing the reading module (not shown), and the NFC antenna 205 reads the electromagnetic wave from the reading module to induce and generate the required power for operating the smart transaction device 200. The chip 202 includes an external contact electrode 202a, an integrated circuit (IC) inside it, which includes at least a microprocessor 208 and a memory 209, and a plurality of fingerprint sensing devices 204 (for example, the plurality of fingerprint sensing devices 104, 104a, 104b, 104c, 104d shown in FIGS. 1(A)-1(B) or single-sided full fingerprint sensing devices 104e and 104f shown in FIG. 1(C)-1(D)) for individually sensing the fingerprints of various fingers of the user (or to individually sense the full fingerprint of the user) and store them in the internal memory 209 of the chip 202 for comparison. During the comparison procedure, the microprocessor 208 inside the chip 202 receives the user's fingerprint data from the plurality of fingerprint sensing devices 204 in real time, and performs fingerprint registration or fingerprint comparison based on the fingerprint data. In addition, the microprocessor 208 inside the chip 202 can also control the status display device 210 to generate a visual card verification status prompt, so that the user knows the status indication of the verification process such as fingerprint registration or fingerprint matching. In a preferred embodiment, the above-mentioned control status display device 210 can be an LED indicator or electronic paper, where the electronic paper can display text messages of the current usage status of the smart card, and the LED indicator can be in constant on, flashing, cycling or changing the light color and other approaches to show the current usage status of the smart card.

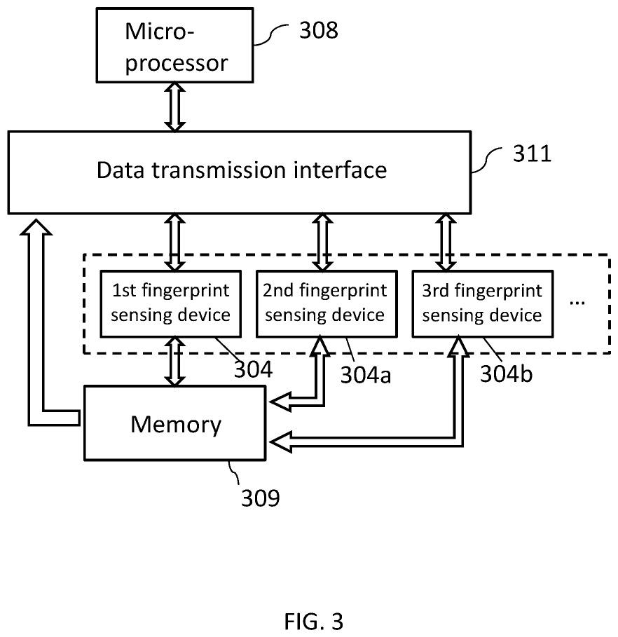

FIG. 3 shows the relationship of data flow between the above-mentioned plurality of sensing devices, microprocessor 308 and memory 309 inside the chip, the hardware illustrated in FIG. 3 includes a data transmission interface 311 for communicating between the microprocessor 308, the plurality of fingerprint sensing devices (i.e. a first fingerprint sensing device 304, a second fingerprint sensing device 304a, and a third fingerprint sensing device 304b), and memory 309. In one embodiment, the plurality of fingerprint sensing devices have been illustrated in FIGS. 1(A)-1(D), for example, which can be a plurality of fingerprint sensing devices 104, 104a, 104b, 104c, 104d as shown in FIGS. 1(A)-1(B) or the single-sided full fingerprint sensing devices 104e, 104f shown in FIG. 1(C)-1(D). The data transmission interface 311 is electrically coupled to the microprocessor 308 to communicate with the microcontroller 308, and the plurality of fingerprint sensing devices (304, 304a, 304b . . . ) are used to sense the fingerprints of user's individual fingers (or used to sense the full fingerprint of the user through the single-sided full fingerprint sensing devices 104e and 104f located on the front and back of the smart transaction device, respectively), and then send the sensed fingerprint data to the microprocessor 308 through the data transmission interface 311, or store the sensed fingerprint data in the memory 309. The data transmission interface 311 is electrically coupled to the plurality of fingerprint sensing devices (304, 304a, 304b . . . ) and the memory 309. In a preferred embodiment, the above-mentioned microprocessor 308 can be a microcontroller with a logic calculation function or a controller with similar functions, the above-mentioned memory 309 can be DRAMs, an EEPROMs, etc.

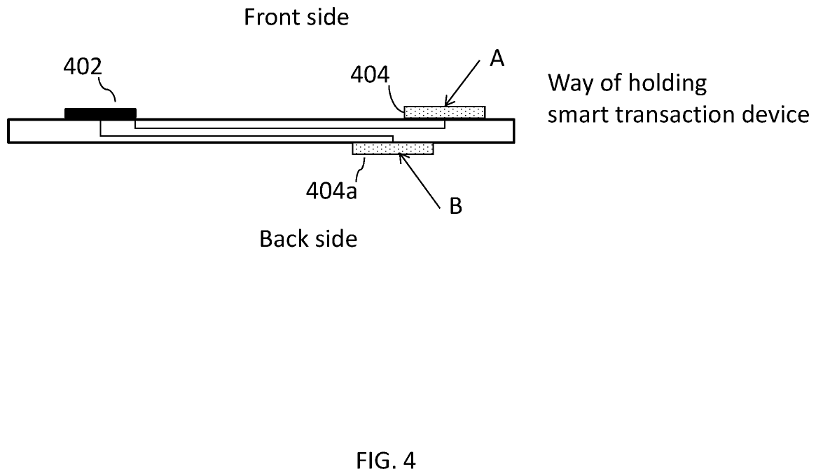

FIG. 4 shows an embodiment of a cross-sectional view of a smart transaction device 400 with fingerprint sensing devices proposed by the present invention. The smart transaction device 400 is provided with a chip 402 on the front side. The chip 402 and a plurality of fingerprint sensing devices (404, 404a . . . ) are electrically connected respectively, where the plurality of fingerprint sensing devices (404, 404a . . . ) respectively arranged on the front and back of the smart transaction device 400 are similar to those individual fingerprint sensing devices shown in FIGS. 1(A)-1(B) or similar to those single-sided full fingerprint sensing devices 104e and 104f shown in FIGS. 1(C)-1(D). In a preferred embodiment, the way in which the user's hand holds the smart transaction device can be held in an up and down manner as shown by arrows A and B indicated in FIG. 4.

When the owner of the smart transaction device uses the device for the first time, pre-operations such as activating a credit card or a smart payment/transaction device should be performed first. The smart transaction device user/owner needs to perform password setting and input fingerprint (which includes inputting all fingerprints of each finger of the dominant hand and stored these data in the memory of the smart transaction device. After the smart transaction device activation process is completed, due to the configuration of the plurality of fingerprint sensing devices proposed in the present invention, it is equivalent to configuring and initiating the full fingerprint detection condition of the user's dominant hand in a specific area of the smart transaction device. For example, the user can choose and set the thumb fingerprint sensing area on the front of the smart transaction device as a fingerprint-detection activating module. In addition, an emergency alarming module can be set by combining the activation of both the thumb fingerprint sensing device on the front of the smart transaction device and the other finger fingerprint sensing device on the back of the smart transaction device, such as the middle finger fingerprint sensing device, an emergency alarming signal will be sent out silently to call for help in emergency situations, such as robbery, kidnapping or armed threat happening. In such situations, user only needs to press the thumb on thumb fingerprint sensing device on the front of the smart transaction device and the other finger, such as middle finger, on the other finger fingerprint sensing device on the back of the device at the same time, the emergency alarming module will be activated immediately. A plurality of pre-set fingerprint matching conditions can be set and used for the next stage of actions, these actions, such as direct financial transactions or verification code input before releasing financial transactions, can't be executed without passing the above pre-set fingerprint matching conditions. In an embodiment, the verification code may be an instant one-time password (OTP) sent by the card or the smart transaction devices issuing institution (for example, the issuing bank). Smart transaction devices made in this way can greatly increase security and reduce the risk of fraudulent use.

For the smart transaction device described in FIGS. 1-4, in another embodiment, it can also integrate with a USB flash drive, so that the USB flash drive has a plurality of fingerprint sensing device with configurations as shown in FIG. 1 and the holding method shown in FIG. 4, to form an USB flash drive containing confidential information. In another embodiment, the implementation of fingerprint sensing devices can also be configured on the upper and lower surfaces of the USB flash drive body with their configurations as shown in FIG. 1 and the holding way as shown in FIG. 4 to form an USB flash drive containing confidential information.

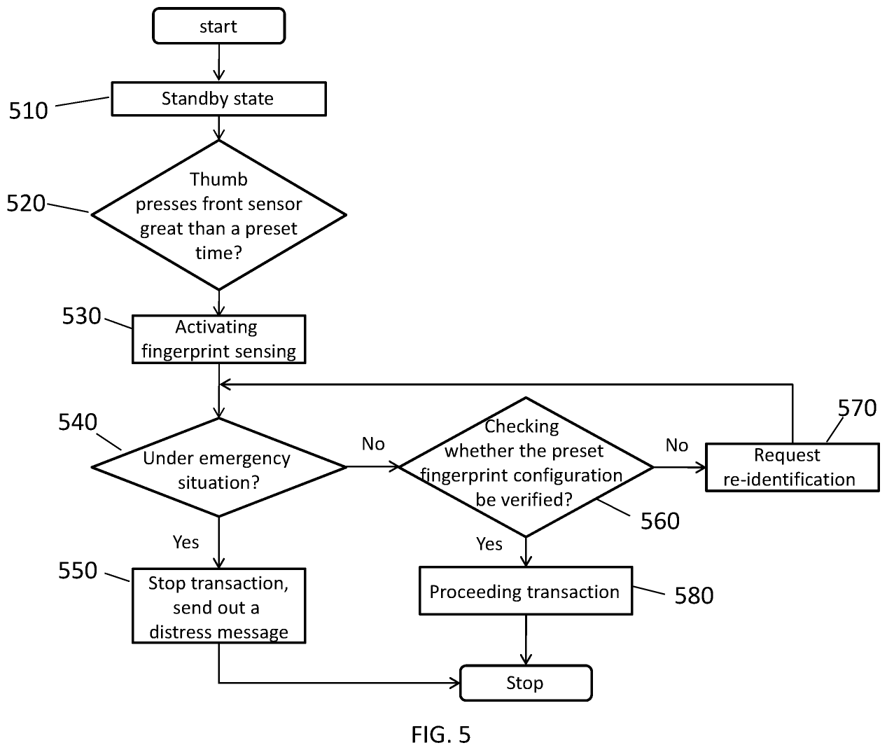

FIG. 5 is a flow chart for explaining the operation method of the smart transaction device according to an embodiment of the present invention. The smart transaction device with fingerprint recognition function is in the standby state before receiving the power detection signal (step 510). The fingerprint sensing system of the smart transaction device is in an OFF state (here, the fingerprint sensing system generally refers to the plurality of fingerprint sensing devices described in the previous paragraphs) to minimize power consumption. The user touches the thumb to press the sensor, which can be any fingerprint sensing device on the front or back of the device, for a preset period of time. In one embodiment, the preset period of time is about a few seconds (step 520). The control switch of the fingerprint sensing system is activated according to the detected signal, and when the fingerprint recognition function is required, the fingerprint sensing module is activated (step 530). When the fingerprint sensor module is activated, it can detect whether the user's is in an emergency situation, such as being hijacked while using the smart transaction device, by checking the user's hand-holding way to the smart transaction device is in the default configuration of emergency state or not (step 540). If so, the smart transaction device sends a distress message through a card reader or ATM and immediately stops the transaction (step 550); otherwise, the smart transaction device verify whether the input fingerprint information is matching the user's default fingerprint configuration information (for example, whether it is a user's preset combination of specified individual fingerprint information) that transmitted and stored in the memory by the microcontroller (step 560), and if the verification is failed, the smart transaction device requests re-identification process (Step 570). After the verification of the input fingerprint information by the smart transaction device is completed, follow-up operations are carried out. For example, user can conduct financial or designated transactions (step 580). In a preferred embodiment, the above-mentioned method of verifying whether the input fingerprint information is the user's preset specified fingerprint configuration information is to transmit the collected user's real time fingerprint combinations to a microcontroller and compare them with the user's preset and stored fingerprint combinations, and then check/verify if they are matched by the microcontroller. In a preferred embodiment, the user's specified fingerprint combination is determined by a particular combinations of the user's fingers holding the smart transaction device.

While various embodiments of the present invention have been described above, it should be understood that they have been presented by a way of example and not limitation. Numerous modifications and variations within the scope of the invention are possible. The present invention should only be defined in accordance with the following claims and their equivalents.

What is claimed is:

1. A smart transaction device with multiple fingerprint recognition comprising:
a device body having a first surface and a second surface on the opposite side; and
a plurality of fingerprint sensing devices being arranged on at least one of the first surface and the second surface for sensing fingerprints of different fingers of a user as access authentication and security enhancement.

2. The smart transaction device with multiple fingerprint recognition of claim 1, wherein the plurality of fingerprint sensing devices include full fingerprint recognition, and the plurality of fingerprint sensing devices are arranged on the first surface and the second surface.

3. The smart transaction device with multiple fingerprint recognition of claim 1, wherein the device body further includes a microcontroller and a memory, the microcontroller is electrically connected to the plurality of fingerprint sensing devices to receive a plurality of fingerprint data of the user, and performs fingerprint registration or fingerprint comparison based on the plurality of fingerprint data.

4. The smart transaction device with multiple fingerprint recognition of claim 1, wherein the plurality of fingerprint sensing devices are capacitive fingerprint recognition sensors.

5. The smart transaction device with multiple fingerprint recognition of claim 1, wherein the plurality of fingerprint sensing devices are fingerprint recognition sensors manufactured by printing, photolithography and etching, laser transfer, fine metal mask sputtering or slit coating process.

6. The smart transaction device with multiple fingerprint recognition of claim 1, wherein the smart transaction device includes all kinds of financial cards, credit cards, electronic tickets, smart ID cards, access cards, fingerprint cards (keys) of laptops or similar electronic devices, remote controls, mobile phones, or USB containing confidential information Flash drive.

7. The smart transaction device with multiple fingerprint recognition of claim 1, wherein materials of the smart transaction device includes plastic, glass, flexible film, or metal.

8. The smart transaction device with multiple fingerprint recognition of claim 1, further includes a status display device controlled by a microcontroller to generate visual verification status prompts of the smart transaction device.

9. The smart transaction device with multiple fingerprint recognition of claim 1, wherein the plurality of fingerprint sensing devices are arranged on the first surface of the device body and the second surface on the opposite side, their configurations are based on user's way of holding the smart transaction device.

10. A smart transaction device with multiple fingerprint recognition comprising:
a device body having a first surface and a second surface on the opposite side; and
a plurality of fingerprint sensing devices being arranged on at least one of the first surface and the second surface for sensing fingerprints of different fingers of a user as access authentication and security enhancement; wherein the smart transaction device includes all kinds of financial cards, credit cards, electronic tickets, smart ID cards, access cards, fingerprint cards (keys) of laptops or similar electronic devices, remote controls, mobile phones, or USB containing confidential information Flash drive; a status display device controlled by a microcontroller for generating visual verification status prompts of the smart transaction device.

11. The smart transaction device with multiple fingerprint recognition of claim 10, wherein the plurality of fingerprint sensing devices include full fingerprint recognition, and the plurality of fingerprint sensing devices are arranged on the first surface and the second surface.

12. The smart transaction device with multiple fingerprint recognition of claim 10, wherein the device body further includes a microcontroller and a memory, the microcontroller is electrically connected to the plurality of fingerprint sensing devices to receive a plurality of fingerprint data of the user, and performs fingerprint registration or fingerprint comparison based on the plurality of fingerprint data.

13. The smart transaction device with multiple fingerprint recognition of claim 10, wherein the plurality of fingerprint sensing devices are capacitive fingerprint recognition sensors.

14. The smart transaction device with multiple fingerprint recognition of claim 1, wherein the plurality of fingerprint sensing devices are fingerprint recognition sensors manufactured by printing, photolithography and etching, laser transfer, fine metal mask sputtering or slit coating process.

15. A method of operating a smart transaction device with multiple fingerprint sensing devices, the smart transaction device having a plurality of fingerprint sensing devices been configured at least on one of a first surface of the smart transaction device and a second surface on the opposite side thereof, and been configured in accordance with user's way of holding the smart transaction device, the method comprising:
activating fingerprint sensing system of the smart transaction device;
verifying whether input multiple fingerprint information through the plurality of fingerprint sensing devices is the user's preset fingerprint configuration information, if verification is failed, the smart transaction device requests a re-identification process; and
proceeding with transaction, after completing verification of the input multiple fingerprint information.

16. The method of operating a smart transaction device with multiple fingerprint sensing devices of claim 15, wherein the method of activating fingerprint sensing system is to use the user's thumb to press the fingerprint sensing device on the first surface of the smart transaction device for more than a predetermined period of time.

17. The method of operating a smart transaction device with multiple fingerprint sensing devices of claim 15, wherein the method of verifying whether the input fingerprint information is the fingerprint configuration information preset by the user is to transmit the user's real time fingerprint combinations to a microprocessor and compare them with the user's preset and stored fingerprint combinations, and then check if they are matched by the microcontroller.

18. The method of operating a smart transaction device with multiple fingerprint sensing devices of claim 17, wherein the microcontroller is embedded inside the smart transaction device.

19. The method of operating a smart transaction device with multiple fingerprint sensing devices of claim 15, wherein the user's fingerprint combination is determined by different combinations of the user's ways of holding the smart transaction device.

20. The method of operating a smart transaction device with multiple fingerprint sensing devices of claim 15, which further includes detecting the posture or manner of the user's fingers holding the smart transaction device to detect whether the user is in the default emergency situations.
